(19) United States
(12) Patent Application Publication
(10) Pub. No.: US 2009/0109653 A1
(43) Pub. Date: Apr. 30, 2009

(54) Electrical socket with emergency lighting device

(76) Inventors: Ching-Huei Wu, San Chung City (TW); Tai-Ho Huang, San Chung City (TW)

Correspondence Address: TROXELL LAW OFFICE PLLC, SUITE 1404, 5205 LEESBURG PIKE, FALLS CHURCH, VA, 22041, US

(21) Appl. No.: 11/976,598

(22) Filed: Oct. 25, 2007

(51) Int. Cl. F21V 33/00

(52) U.S. Cl. 362/95

(57) ABSTRACT

An electrical socket with emergency lighting device is disclosed, including a housing, a circuit board, at least one light-emitting diode (LED), at least one socket, a panel and a power accumulation unit. The circuit board, the power accumulate unit, the at least one LED, and the at least one socket are arranged inside the housing. The circuit board is electrically connected to the at least one light-emitting diode and is also electrically connected to an external power source. The power accumulation unit is electrically connected to the external power source via the circuit board to form a circuit loop. The panel is releasably mounted to the housing and forms an opening corresponding to each of the at least one socket to expose the socket.

### BACKGROUND OF THE INVENTION

1. Field of the Invention

The present invention relates to an electrical socket with an emergency lighting device combined therein, which is formed by a combination of a casing, a circuit board, at least one light-emitting diode, at least one socket, a panel, and a power accumulation unit so that the electrical socket, although plugged in a wall outlet to serve as an emergency light at a power failure situation, does not occupy the wall outlet for a corresponding socket is provided, and is thus applicable to electrical socket or similar structures.

2. The Related Arts

Emergency lighting device that is commonly available in the market is provided to mount to a wall surface or in a stairway exit. The emergency lighting device is provided with a storage battery, which is charged when power is normally supplied through for example an electrical main, and which discharge to power the emergency lighting device when an emergency situation causing power failure occurs.

The known emergency lighting device can only work by being plugged into a wall outlet or other electrical socket to receive the external power source. This is particularly true when the conventional emergency lighting device is arranged in a stairway exit, for there is commonly no wall outlet arranged in the stairway. Further, the conventional emergency lighting device uses a light bulb to give off light in emergency situation and the light bulb is generally known be being very power consuming and taking more power than for example a light-emitting diode. In addition, to install the emergency lighting device, which requires constant charging by being normally plugged in an electrical socket, the emergency lighting device thus occupy the wall outlet or electrical socket into which the emergency lighting device is plugged. This causes problems in using other electrical devices.

Thus, the present invention is aimed to provide an emergency lighting device that can serve to provide emergency lighting but occupying no electrical socket or wall outlet to overcome the above discussed drawbacks.

### SUMMARY OF THE INVENTION

An objective of the present invention is to provide an electrical socket with emergency lighting device, which comprises an assembly of a housing, a circuit board, at least one light-emitting diode, at least one socket, a panel, and a power accumulation unit, wherein a socket structure formed of the housing and the panel defines an interior space that accommodates the power accumulation unit, the circuit board, the at least one light-emitting diode, and the at least one socket, the circuit board being electrically connected to the at least one light-emitting diode and is further connected to a power source, the power accumulation unit being electrically connected to the circuit board and electrically connected to the external power source via the circuit board to form a circuit loop, so that the at least one light-emitting diode functions as an emergency lighting in an emergency, power failure situation without any problem associated with wall outlet being occupied by the emergency lighting device to thereby ensure convenience of operation and enhanced practicability.

To realize the above objective, in accordance with the present invention, there is provided an electrical socket with emergency lighting device comprising a housing, a circuit board, at least one light-emitting diode, at least one socket, a panel, and a power accumulation unit. The housing forms an interior space and the circuit board is arranged in the interior space of the housing. The circuit board is electrically connected to the at least one light-emitting diode. The circuit board is also electrically connected to an external power source. The at least one socket is arranged inside the housing and is electrically connected to the external power source. The panel is releasably mounted to the housing and forms an opening corresponding to each of the at least one socket. The power accumulation unit is arranged inside the housing and is electrically connected to the circuit board so that the power accumulation unit is electrically connected to the external power source via the circuit board to form a circuit loop. With such an arrangement, an electrical device comprising a combination of an electrical socket and emergency lighting device is provided, which demonstrates enhanced practicability and convenience.

The present invention will become more obvious from the following description when taken in connection with the accompanying drawings, which show, for purposes of illustration only, a preferred embodiment in accordance with the present invention. In the drawings:

### BRIEF DESCRIPTION OF THE DRAWINGS

FIG. 1 is a perspective view showing an electrical socket with emergency lighting device constructed in accordance with an embodiment of the present invention;

FIG. 2 is an exploded view of the electrical socket with emergency lighting device in accordance with the present invention;

FIG. 3 is a cross-sectional view of the electrical socket with emergency lighting device in accordance with the present invention; and

FIG. 4 is a perspective view illustrating a practical application of the electrical socket with emergency lighting device in accordance with the present invention.

### DETAILED DESCRIPTION OF THE PREFERRED EMBODIMENT

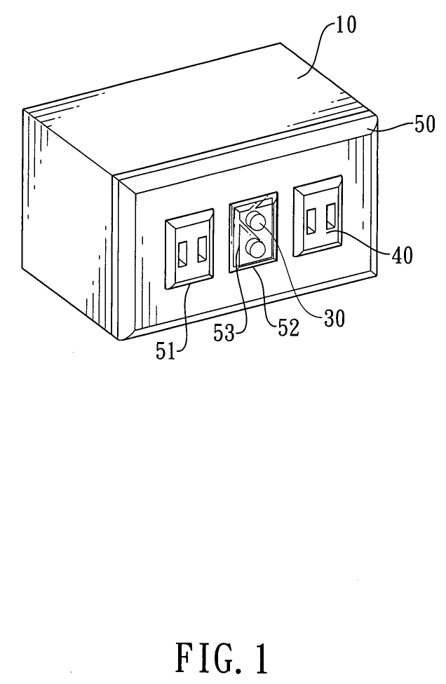

With reference to the drawings and in particular to FIGS. 1-3, an electrical socket with emergency lighting device constructed in accordance with the present invention by combining an emergency lighting device with an electrical socket device is illustrated. The electrical socket with emergency lighting device that comprises a combination of the emergency lighting device and the electrical socket device comprises a housing 10 in which an interior space is defined for accommodating a circuit board 20, at least one socket 40, and a power accumulation unit 60 through an opening (not labeled) and a panel 50 mounted to and closing the opening of the housing 10.

The circuit board 20 is accommodated in the interior space of the housing 10 and is electrically connected to a light-emitting diode (LED) 30. The circuit board 20 is also connected to an external power source 70. The circuit board 20 forms thereon a power supply circuit and a control circuit for carrying out power conversion, power accumulation, and power supply. In the embodiment illustrated, the at least one LED 30 is mounted on the circuit board 20 and is in electrical connection with the circuit board 20. However, the LED 30 can be arranged at a location offsetting from the circuit board 20 and at any location inside the housing 10 with electrical connection formed between the LED 30 and the circuit board 20.

The at least one electric socket 40 is also arranged inside the housing 10 and is electrically connected to the external power source 70. In the embodiment illustrated, two electrical sockets 40, which constitute together the electrical socket device, are included in the housing 10. The electrical socket 40 can be set at any desired location inside the housing 10 and electrically connected to the external power source 70.

The panel 50 is mounted to the housing 10 to cover the opening of the housing 10. Preferably, the panel 50 is mounted to the housing in a releasable manner. The panel 50 forms an opening 51 corresponding to each of the at least one socket 40. A retainer plate 11 is further provided inside the housing 10. However, it is noted that if desired, the retainer plate 11 can be removed, and under this situation that the retainer plate 11 is removed, the panel 50 is made light-transmittable to allow light emitted from the LED 30 to transmit therethrough. The retainer plate 11 is arranged between the panel 50 and the housing 10 and forms an opening 111 corresponding to each of the at least one socket 40. The opening 111 of the retainer plate 11 corresponds to the opening 51 of the panel 50 that is formed in association with each of the at least one socket 40 for properly positioning the socket 40 in such a way that the socket 40 is exposed through the opening 51 defined in the panel 50. In the embodiment illustrated, since two sockets 40 are arranged inside the housing 10, the retainer plate 11 forms two openings 111 corresponding to the sockets 40, and similarly, the panel 50 also forms two openings 51 corresponding to the sockets 40 and the openings 111 of the retainer plate 11. The retainer plate 11 is further provided with a through hole 112 corresponding to each of the at least one LED 30, and the panel 50 is made light-transmittable to allow light emitted from the LED 30, which travels through the through hole 112 of the retainer plate 11, to transmit therethrough; or alternatively, the panel 50 can be made non-light-transmittable, and instead, a through hole 52 is formed in the panel 50 at a location corresponding to each through hole 112 formed in the retainer plate 11 and also at the direction along which the light emitted from the associated LED 30 travels. An additional light-transmitting cap 53 is provided to cover the through hole 52 of the panel 50, so that the light emitted from the LED 30 is allowed to transmit to outside the housing 10 through the through holes 112 and 52 of the retainer plate 11 and the panel 50 and the light-transmitting cap 53.

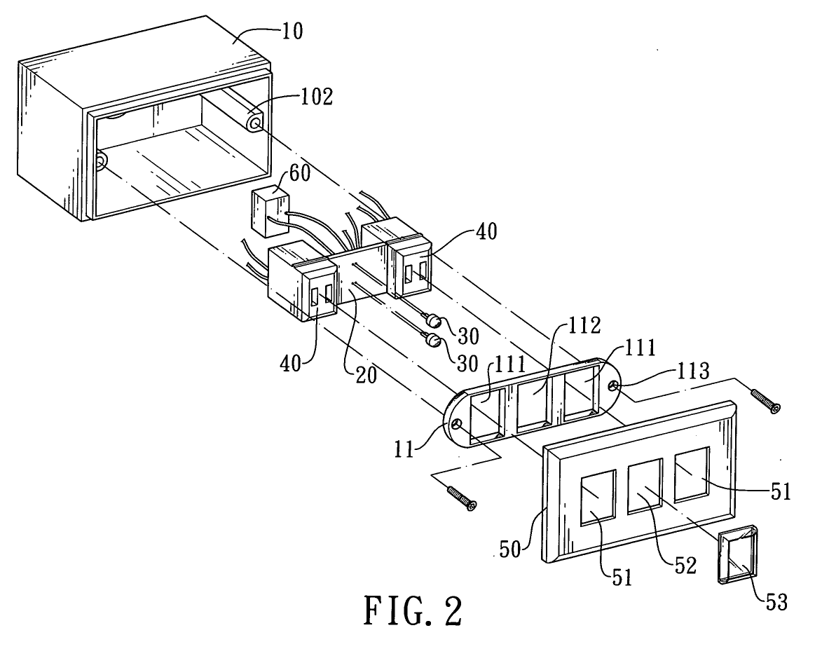

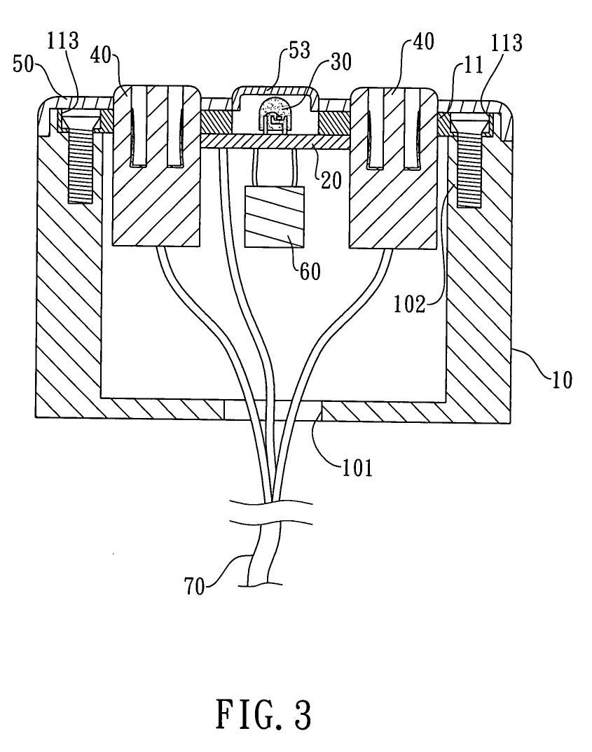

The power accumulation unit 60 is arranged in the interior space of the casing 10. The power accumulation unit 50 can be for example a rechargeable cell or a storage battery. The power accumulation unit 60 is electrically connected to the circuit board 20. As shown in FIGS. 2 and 3, in the embodiment illustrated, the power accumulation unit 60 is arranged below the circuit board 20 and in practical applications, the power accumulation unit 60 can be arranged at any desired location in the interior space of the casing 10. The power accumulation unit 60 is electrically connected to the power source 70 by the circuit board 20 to form a circuit loop

In the embodiment illustrated, the circuit board 20 is arranged between the two sockets 40. However, it is note that the circuit board 20 can be set at any desired location in the interior space of the housing 10. The housing 10 forms a passage 101, preferably at a rear wall thereof, to allow the circuit board 20 and the at least one socket 40 to electrically connect to the external power source 70. In the embodiment illustrated, the retainer plate 11 forms mounting holes 113 on opposite lateral edges thereof. Two mounting portions 102 are formed inside the housing 10 and at opposite side walls of the housing 10, and each mounting portion 102 forms a mounting hole corresponding to the mounting hole 113 of the retainer plate 11. Thus, a fastener, such as a bolt or screw, is received through each of the mounting holes 113 of the retainer plate 11 and engages the mounting hole of the corresponding mounting portion 102 of the housing 10 to secure the retainer plate 11 to the housing 10 together.

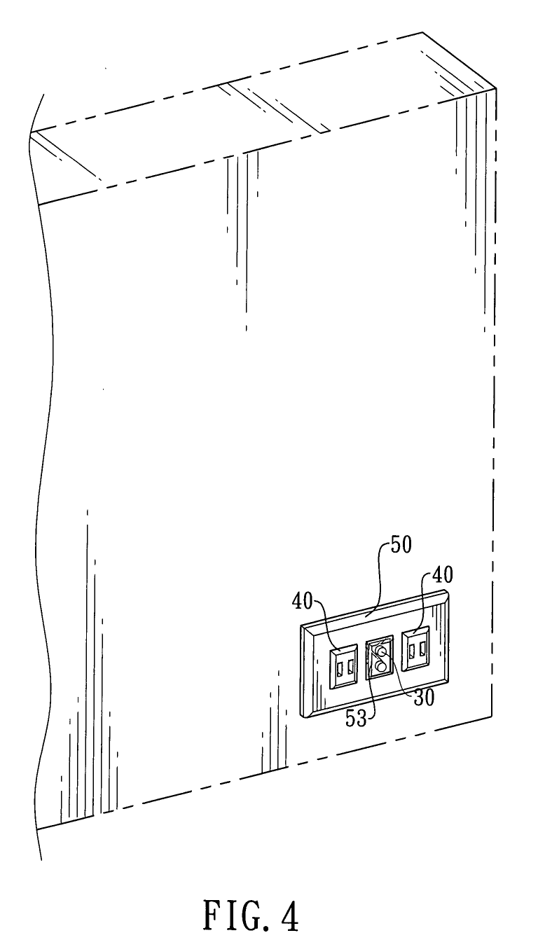

Also referring to FIGS. 1-4, the electrical socket with emergency lighting device of the present invention features an assembly of a housing 10, a circuit board 20, at least one LED 30, at least one socket 40, a panel 50, and a power accumulation unit 60 with the housing 10 accommodated in a cavity defined in a building wall which is provided to accommodate a wall outlet. The circuit board 20 is electrically connected to the at least one LED 30 and the power accumulation unit 60 and the circuit board 20 is electrically connected to the external power source 70, which can be the electrical main that is designated to supply power to the wall outlet, so that the power accumulation unit 60 is electrically connected to the external power source 70 via the circuit board 20 to thereby form a circuit loop. In a normal situation where no emergency occurs, the power accumulation unit 60 receives electrical power from the external power source 70 and is thus charged and power is accumulated in the power accumulation unit 60. When power failure occurs due to any unexpected situation or emergency, the power accumulated in the power accumulation unit 60 is discharged to power the at least one LED 30, whereby the at least one LED 30 may serve as an emergency lighting device. In this way, no additional emergency lighting facility and power sockets are needed. Consequently, when power is normally supplied by the external power source 70, the electrical socket with emergency lighting device of the present invention factually occupies no wall outlet, for a plug of another electrical appliance (not shown) can be connected to the external power source 70 through the electrical socket that constitute in part the electrical socket with emergency lighting device of the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An electrical socket with emergency lighting device comprising:
a housing forming an interior space;
a circuit board arranged in the interior space of the housing and electrically connected to at least one light-emitting diode, the circuit board being adapted to electrically connect to an external power source;
at least one socket arranged inside the housing and adapted to electrically connect to the external power source;
a panel releasably mounted to the housing and forming a first opening corresponding to each of the at least one socket; and
a power accumulation unit arranged in the interior space of the housing and electrically connected to the circuit board, the power accumulation unit being electrically connected to the external power source through the circuit board.

2. The electrical socket with emergency lighting device as claimed in claim 1, wherein the housing comprises a retainer plate arranged between the panel and the housing, the retainer plate forming a second opening corresponding to each of the at least one socket and the first opening defined in the panel for positioning the socket and exposing the socket through the panel, and wherein the retainer plate further forms a through hole corresponding to each of the at least one light-emitting diode and the panel is light-transmittable so that light emitted from the at least one light-emitting diode is allowed to transmit to outside the housing through the through hole of the retainer plate and the light-transmittable panel.

3. The electrical socket with emergency lighting device as claimed in claim 1, wherein the panel is made light-transmittable.

4. The electrical socket with emergency lighting device as claimed in claim 1, wherein the panel forms a through hole corresponding to the light-emitting diode and covered by a light-transmitting cap to allow transmission of light emitted from the light-emitting diode.

5. The electrical socket with emergency lighting device as claimed in claim 2, wherein the panel forms a through hole corresponding to the light-emitting diode and covered by a light-transmitting cap, the through hole of the panel corresponding to the through hole of the retainer plate to allow transmission of light emitted from the light-emitting diode.

6. The electrical socket with emergency lighting device as claimed in claim 1, wherein the power accumulation unit comprises a rechargeable cell.

7. The electrical socket with emergency lighting device as claimed in claim 1, wherein the power accumulation unit comprises a storage battery.
